(19) United States
(12) Patent Application Publication
(10) Pub. No.: US 2005/0166666 A1
(43) Pub. Date: Aug. 4, 2005

(54) Piping structure having leak detection function and leak detector

(75) Inventor: Masayuki Tsukagoshi, Sagamihara-shi (JP)

Correspondence Address: YOUNG & THOMPSON, 745 SOUTH 23RD STREET, 2ND FLOOR, ARLINGTON, VA, 22202, US

(73) Assignee: LASERFRONT TECHNOLOGIES, INC., SAGAMIHARA-SHI (JP)

(21) Appl. No.: 11/048,773

(22) Filed: Feb. 3, 2005

(30) Foreign Application Priority Data
Feb. 4, 2004 (JP) 2004-028700

(51) Int. Cl. G01M 3/08

(52) U.S. Cl. 73/49.1

(57) ABSTRACT

A covering member having a valve encloses a flexible hose to form a double pipe. Gas supply pipe fittings are attached to respective ends of the double pipe to form a hermetic space between the flexible hose and covering member. The covering member also has a pressure-measuring device to which a decision unit equipped with an alarm device is connected. The same gas or liquid as the one flowing through the flexible hose is introduced to the hermetic space from the valve provided in the covering member, and sealed in the hermetic space by closing the valve. The pressure in the hermetic space is set so as to be higher than the pressure produced in the flexible hose when the gas or liquid is flowing. The pressure-measuring device measures the pressure in the hermetic space while the gas or liquid flows in the flexible hose, and the decision unit compares the measured value with a reference value. As a result, if the value measured by the pressure-measuring device is lower than the reference value, the decision unit decides that a breakage has occurred and then the alarm device activates an alarm.

### BACKGROUND OF THE INVENTION

1. Field of the Invention

The present invention relates to a piping structure having leak detection function that allows gas or liquid to flow therethrough, and to a leak detector attached to this piping structure, more particularly to a piping structure having leak detection function and a leak detector that are preferably used in equipment for manufacturing precision devices such as semiconductor devices, liquid crystal display devices, and other devices.

2. Description of the Related Art

Generally, a piping structure using a stainless steel flexible hose is connected to chemical vapor deposition (CVD) equipment used for manufacturing precision devices, such as semiconductor devices, liquid crystal display devices, and other devices, to supply a gas such as argon or the like into the chamber. FIG. 1 is a cross-sectional side view illustrating a conventional piping structure. FIG. 2 is a cross-sectional side view illustrating a state when a breakage occurs in the conventional piping structure 100 shown in FIG. 1. As shown in FIG. 1, in the conventional piping structure 100, gas supply pipe fittings 102 and 103, such as metal gasket face seal fittings or the like, are attached to respective ends of a flexible hose 101. Respective ends of the conventional piping structure 100 are connected through the respective fittings 102 and 103 to a gas supply section and CVD equipment, and argon gas 104 or other gas flows through the piping structure 100 from the gas supply section to the CVD equipment.

The stainless steel flexible hose 101 used in the conventional piping structure 100 tends to be broken as it is frequently used. As shown in FIG. 2, if the flexible hose 101 is broken, not only leaks the gas flowing through the flexible hose 101, such as the argon gas 104 or other gas, from a breakage 110, but also air 105 may flow into the flexible hose 101 from the breakage 110. If the air 105 is mixed with the gas flowing through the piping structure 100, such as the argon gas 104 or other gas, the process in the CVD equipment is adversely affected. The conventional piping structure 100, however, cannot detect the leakage of the gas flowing therethrough. Therefore, a problem with using the conventional piping structure 100 is that time-consuming various investigations will be required until it is found out that the process in the CVD equipment deteriorates due to the occurrence of a leakage. Another problem is that, even if it is recognized that a leakage occurs, it takes long time to specify the origin of the leakage or the breakage 110.

Conventional methods for detecting the occurrence of a leakage are described in, for example, Japanese Utility Model Laid-Open Publication No. 145132/1987 and Japanese Patent Laid-Open Publication No. 54800/2000, in which the piping structure is formed to be a double pipe structure and the variation of the pressure in the hermetic space formed between the inner and outer pipes in the double pipe structure is measured.

The gas leak detector described in Japanese Utility Model Laid-Open Publication No. 145132/1987 detects the leakage of a gas flowing through a gas pipe in such a way that a container is hermetically attached to the periphery of the gas pipe so as to wrap around the gas pipe, a liquid or gas is sealed in the space between the container and gas pipe so as to produce a given pressure, and the variation of the pressure of the liquid or gas is detected by a pressure sensor.

The gas leak detection system described in Japanese Patent Laid-Open Publication No. 54800/2000 is such that in the space between the outer and inner pipes, an inert gas is sealed to produce higher pressure than the pressure in the inner pipe and a detection unit for detecting the pressure of the inert gas is provided, and an alarm is activated when the pressure of the inert gas decreases to a level less than a given value.

There are also other methods for detecting the occurrence of a leakage other than the methods of measuring the variation of the pressure. As one example, Japanese Patent Laid-Open Publication No. 340236/2002 discloses a piping structure used in a cryogenic refrigeration system, in which a soft vinyl chloride resin sheet or a synthetic resin bellows pipe encloses a stainless steel flexible hose, and a detector, such as a helium leak detector or the like, detects helium gas accumulating in the hermetic space between the stainless steel flexible hose and the resin sheet or bellows pipe when a leakage occurs.

As another example, Japanese Patent Laid-Open Publication No. 349800/2002 discloses a security system used in an oil or gas pipeline, in which a covering pipe is attached outside a pipe, the space formed between the pipe and covering pipe is sectioned into a plurality of hermetic spaces, and each segment of the sectioned hermetic spaces has a sensor that can transmit a different kind of signal wave. Since the pipeline security system described in this reference transmits a different kind of signal wave per sectioned hermetic space, the place where a leakage occurs can be specified per sectioned hermetic space.

The conventional methods described above, however, have the following problem. A piping structure in the equipment used for manufacturing precision devices, such as semiconductor devices, liquid crystal display devices, and other devices, is required not only to detect the occurrence of a leakage and specify where the leakage occurs, but also to minimize degradation of the quality caused by the occurrence of a leakage including the contamination of the impurity into the product during fabrication. The conventional methods, however, cannot solve this problem.

### SUMMARY OF THE INVENTION

An object of the present invention is to provide a piping structure having leak detection function and a leak detector that are capable of detecting the occurrence of a breakage in a pipe through which a gas or liquid flows and of minimizing the effect on the product caused by the breakage in the pipe.

A piping structure having leak detection function according to the present invention comprises: a pipe for allowing a gas or liquid to flow therethrough; a covering member for enclosing the pipe to form a hermetic space between the covering member and the pipe; a pressure measuring device for measuring a pressure in the hermetic space; and a decision unit for deciding on the basis of a value measured by the pressure measuring device whether a breakage has occurred in the pipe. And the same gas or liquid as the one flowing through the pipe is sealed in the hermetic space.

Another piping structure having leak detection function according to the present invention comprises: a pipe for allowing a gas or liquid to flow therethrough; a covering member for enclosing the pipe to form a hermetic space between the covering member and the pipe; a valve provided in the covering member; a pressure measuring device for measuring a pressure in the hermetic space; and a decision unit for deciding on the basis of a value measured by the pressure measuring device whether a breakage has occurred in the pipe. And the same gas or liquid as the one flowing through the pipe is sealed in the hermetic space through the valve.

According to the present invention, since the covering member encloses the pipe that allows a gas or liquid to flow therethrough and the pressure measuring device measures the variation of the pressure in the hermetic space formed between the covering member and the pipe, the occurrence of a breakage in the pipe can be detected. Further, since the same gas or liquid as the one flowing through the pipe is sealed in the hermetic space, even if a breakage occurs in the pipe, the gas or liquid flowing through the pipe has no risk of being mixed with the impurity, thereby minimizing the effect on the product processed in the equipment to which the invented piping structure is connected.

The piping structure having leak detection function according to the present invention may be connected to chemical vapor deposition equipment. In this case, a source gas or an ambient gas to be supplied to the chemical vapor deposition equipment is passed through the pipe.

In the piping structure having leak detection function according to the present invention, the pressure in the hermetic space may be set to be higher than a pressure produced in the pipe when a gas or liquid flows therethrough. The leakage from the pipe can thereby be prevented and therefore its effect on the product processed in the equipment having the invented piping structure is minimized, because the gas or liquid sealed in the hermetic space flows into the pipe when a breakage occurs in the pipe.

Further, a flexible hose may be used as the pipe. In this case, the flexible hose may preferably be made of a stainless steel material. Since the stainless steel flexible hose improves bend resistance and does not evolve gas, an adverse effect on the product processed in the equipment having the invented piping structure is prevented.

Furthermore, the covering member is made of, for example, a synthetic resin, thereby enabling the bend resistance to be improved and the lifetime of the pipe to be extended.

Still furthermore, the piping structure having leak detection function according to the present invention may further comprise an alarm device for activating an alarm when the decision unit decides that a breakage has occurred.

A leak detector according to the present invention comprises: a covering member for enclosing a pipe allowing a gas or liquid to flow therethrough to form a hermetic space between the covering member and the pipe; a pressure measuring device for measuring a pressure in the hermetic space; and a decision unit for deciding on the basis of a value measured by the pressure measuring device whether a breakage has occurred in the pipe. And the same gas or liquid as the one flowing through the pipe is sealed in the hermetic space.

Another leak detector according to the present invention comprises: a covering member for enclosing a pipe allowing a gas or liquid to flow therethrough to form a hermetic space between the covering member and the pipe; a valve provided in the covering member; a pressure measuring device for measuring a pressure in the hermetic space; and a decision unit for deciding on the basis of a value measured by the pressure measuring device whether a breakage has occurred in the pipe. And the same gas or liquid as the one flowing through the pipe is sealed in the hermetic space from the valve.

The leak detector according to the present invention may further comprise an alarm device for activating an alarm when the decision unit decides that a breakage has occurred.

According to the present invention, since the covering member encloses the pipe and the pressure measuring device measures the variation of the pressure in the hermetic space formed between the covering member and the pipe, the occurrence of a breakage in the pipe can be detected. Further, since the same gas or liquid as the one flowing through the pipe is sealed in the hermetic space, even if a breakage occurs in the pipe, there is no risk that the gas or liquid flowing through the pipe is mixed with the impurity, thereby minimizing the effect on the product.

### BRIEF DESCRIPTION OF THE DRAWINGS

FIG. 1 is a cross-sectional side view schematically illustrating a conventional piping structure;

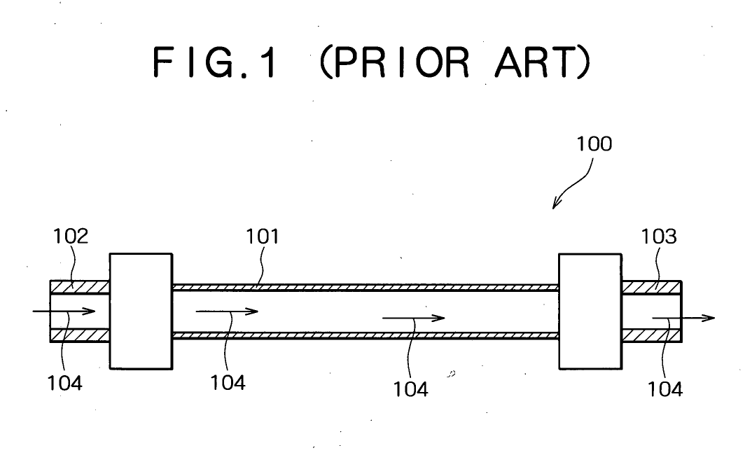

FIG. 2 is a cross-sectional side view illustrating a state when a breakage occurs in the conventional piping structure 100 shown in FIG. 1;

FIG. 3 is a cross-sectional side view illustrating a piping structure structure of an embodiment of the present invention; and

FIG. 4 is a cross-sectional side view illustrating a state when a breakage occurs in the piping structure 10 shown in FIG. 3.

### DETAILED DESCRIPTION OF THE PREFERRED EMBODIMENT

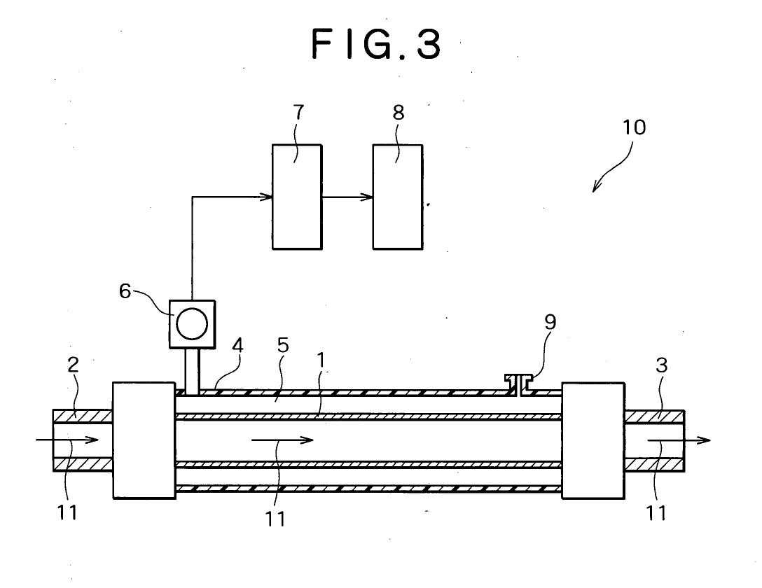

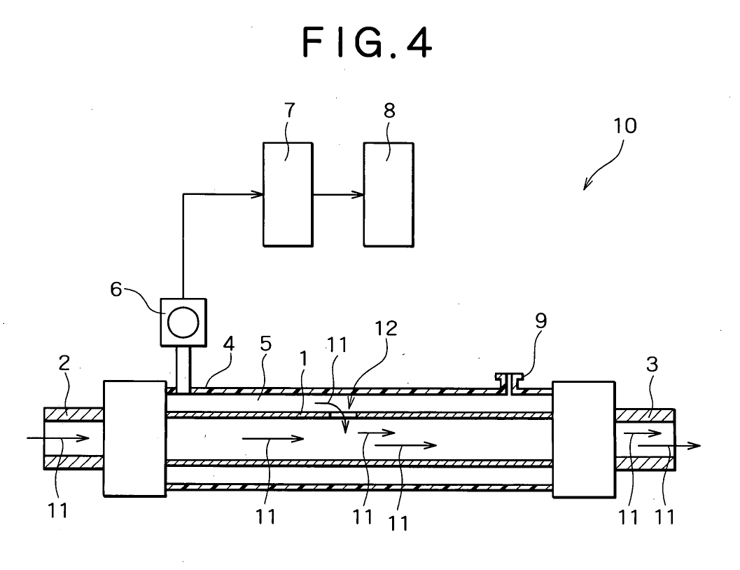

A piping structure having leak detection function according to an embodiment of the present invention will now be described with reference to the attached drawings. FIG. 3 is a cross-sectional side view illustrating a piping structure of the present embodiment. FIG. 4 is a cross-sectional side view illustrating a state when a breakage occurs in the piping structure 10 shown in FIG. 3. As shown in FIG. 3, in the piping structure 10 of the present embodiment, a covering member 4 is provided so as to enclose a flexible hose 1 that allows a gas or liquid to flow therethrough, with a given space between the covering member 4 and the outer surface of the flexible hose 1. That is, the piping structure 10 has a double pipe structure comprising the flexible hose 1 and covering member 4. Gas supply pipe fittings 2 and 3, such as metal gasket face seal fittings or the like, are also attached to respective ends of the double pipe, so that a hermetic space 5 is formed by the flexible hose 1, the gas supply pipe fittings 2 and 3, and the covering member 4.

It is desired that the flexible hose 1 in the piping structure 10 of the present embodiment have bend resistance and do not evolve gas, so it may be formed of, for example, a stainless steel material. It is also desired that the covering member 4 have both weather resistance and bend resistance, so it may be formed of, for example, a synthetic resin.

Further, in the piping structure 10 of the present embodiment, the covering member 4 has a valve 9 through which the same gas or liquid as the one flowing through the flexible hose 1 is introduced to the hermetic space 5 formed in the piping structure 10, i.e., the space between the flexible hose 1 and covering member 4. In this case, the pressure of the hermetic space 5 is set so as to be higher than the pressure produced in the flexible hose 1 when a gas or liquid is passed through the piping structure 10. Then, after the valve 9 has been closed, the set pressure is maintained.

A pressure-measuring device 6 that measures the pressure of the hermetic space 5 is also attached to the covering member 4. The pressure-measuring device 6 may be any device that can directly and electrically obtain the measurement result; for example, a diffused semiconductor strain gauge can be used.

Further, a decision unit 7 is connected to the pressure-measuring device 6. The decision unit 7 decides whether a breakage has occurred, by comparing the value measured by the pressure-measuring device 6 with a reference value (a pressure set when the gas or liquid is sealed in the hermetic space 5). An alarm device 8 is further connected to the decision unit 7. The alarm device 8 activates an alarm if the decision unit 7 decides that a breakage has occurred.

As described above, the piping structure 10 of the present embodiment has a leak detector, which is provided with the covering member 4 enclosing the flexible hose 1, the valve 9 for introducing a gas or liquid to the hermetic space 5, the pressure measuring device 6 for measuring the pressure in the hermetic space 5, the decision unit 7 for deciding from the variation of the pressure in the hermetic space 5 whether a breakage has occurred, and the alarm device 8 for activating an alarm when a breakage occurs.

The piping structure 10 of the present embodiment can be used in equipment for manufacturing precision devices such as semiconductor devices, liquid crystal display devices, and other devices; for example, it is connected to CVD equipment and a source gas or an ambient gas to be supplied to the CVD equipment is passed through the flexible hose 1.

Next, the operation of the piping structure 10 according to the present embodiment will be described with reference to a case in which the flexible hose 1 is connected to CVD equipment and argon gas 11 is passed through the flexible hose 1. First, respective ends of the flexible hose 1 are connected through the respective gas supply pipe fittings 2 and 3 to a gas supply section (not shown) and the CVD equipment (not shown). Next, the argon gas supplied to the CVD equipment, that is, the argon gas having the same purity as the argon gas 11 flowing through the flexible hose 1, is sealed in the hermetic space 5 from the valve 9. In this case, the pressure in the hermetic space 5 is set so as to be higher than the pressure produced in the flexible hose 1 when the argon gas 11 is passed through the piping structure 10. Then, the gas supply section starts supplying the argon gas 11, which flows through the flexible hose 1 to the CVD equipment.

In the piping structure 10 of the present embodiment, while the argon gas 11 flows through the flexible hose 1, the pressure measuring device 6 measures the pressure in the hermetic space 5 and converts the measured result to an electrical signal to output to the decision unit 7. The decision unit 7 then compares the value measured by the pressure measuring device 6 with a preset reference value (a pressure set when the gas or liquid is sealed in the hermetic space 5) to decide whether a breakage has occurred.

As shown in FIG. 4, in the piping structure 10 of the present embodiment, since the pressure in the hermetic space 5 is higher than the pressure in the flexible hose 1, if a breakage 12 occurs in the flexible hose 1, the argon gas sealed in the hermetic space 5 leaks into the flexible hose 1, resulting in decrease in the pressure of the hermetic space 5. The decision unit 7 then decides that a breakage has occurred, if the value measured by the pressure measuring device 6 becomes a lower value than the preset reference value. If the decision unit 7 decides that a breakage has occurred, then it outputs a signal to the alarm device 8. The alarm device 8 then activates an alarm according to this signal.

In the piping structure 10 of the present embodiment, the pressure measuring device 6 monitors the variation of the pressure in the hermetic space 5 while the argon gas 11 flows through the flexible hose 1. Therefore, even if the flexible hose 1 is broken, the breakage can be detected immediately after it has occurred. Further, in the piping structure 10 of the embodiment, since the pressure in the hermetic space 5 is higher than the pressure in the flexible hose 1, even if the breakage 12 occurs in the flexible hose 1, the leakage from the flexible hose 1 can be prevented. Furthermore, since the argon gas sealed in the hermetic space 5 has the same purity as the argon gas 11 flowing through the flexible hose 1, even if the argon gas sealed in the hermetic space 5 leaks into the flexible hose 1 from the breakage 12, there is no effect on the product processed in the CVD equipment. In addition, since the flexible hose 1 is enclosed by the covering member 4, the lifetime of the flexible hose 1 extends.

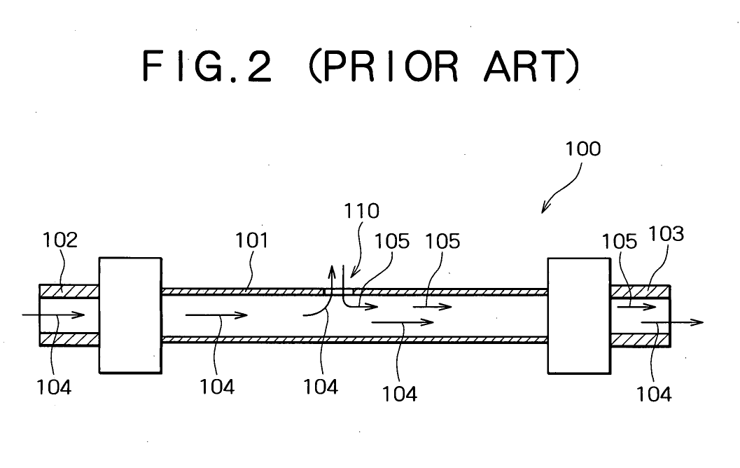

Contrarily, as in the conventional methods described above, if a gas different from the gas flowing through the flexible hose 1 is sealed in the hermetic space 5 so that its pressure becomes higher than the pressure in the flexible hose 1, when the flexible hose 1 is broken, the gas sealed in the hermetic space 5 leaks into the flexible hose 1 from the breakage 12, resulting in an adverse effect on the product processed in the CVD equipment. If air is sealed in the hermetic space 5, for example, the air is mixed with the argon gas 11 flowing through the flexible hose 1, as in the conventional piping structure 100 shown in FIG. 2. Therefore, the impurity is brought into the product being processed in the CVD equipment.

In the above description of the operation of the piping structure 10, a case has been described in which the argon gas 11 is passed through the flexible hose 1 and the argon gas sealed in the hermetic space 5 has the same purity as the argon gas 11, but the present invention is not limited to this case. A gas other than argon gas or liquid may be supplied in the flexible hose 1, and the same gas or liquid as the one flowing through the flexible hose 1 may be sealed in the hermetic space 5. In this case, the same effects as in the case using argon gas can also be obtained.

In the piping structure 10 of the present embodiment, a single covering member 4 encloses whole flexible hose 1, but the present invention is not limited to this structure. The flexible hose 1 may be enclosed by a plurality of covering members. If a pressure measuring device is additionally attached to each of the covering members to detect the variation of the pressure, when a breakage has occurred in the flexible hose 1, the inspection can be focused on the portion where the alarm has been activated. The position of the breakage can thereby be specified quickly.

In the piping structure 10 of the present embodiment, the covering member 4 has the valve 9 through which the same gas or liquid as the one flowing through the flexible hose 1 is sealed in the hermetic space 5, but the present invention is not limited to this case. The same gas or liquid as the one flowing through the flexible hose 1 may be sealed in the hermetic space 5 by other methods or with other members, without providing the valve 9.

1. A piping structure having leak detection function, comprising:
a pipe for allowing a gas or liquid to flow therethrough;
a covering member for enclosing said pipe to form a hermetic space between said covering member and said pipe;
a pressure measuring device for measuring a pressure in said hermetic space; and
a decision unit for deciding on the basis of a value measured by said pressure measuring device whether a breakage has occurred in said pipe, wherein
the same gas or liquid as the one flowing through said pipe is sealed in said hermetic space.

2. The piping structure having leak detection function according to claim 1, being connected to chemical vapor deposition equipment, wherein a source gas or an ambient gas to be supplied to said chemical vapor deposition equipment is passed through said pipe.

3. The piping structure having leak detection function according to claim 1, wherein the pressure in said hermetic space is set to be higher than a pressure produced in said pipe when a gas or liquid flows therethrough.

4. The piping structure having leak detection function according to claim 1, wherein said pipe is a flexible hose.

5. The piping structure having leak detection function according to claim 4, wherein said flexible hose is made of a stainless steel material.

6. The piping structure having leak detection function according to claim 1, wherein said covering member is made of a synthetic resin.

7. The piping structure having leak detection function according to claim 1, further comprising an alarm device for activating an alarm when said decision unit decides that a breakage has occurred.

8. A piping structure having leak detection function, comprising:
a pipe for allowing a gas or liquid to flow therethrough;
a covering member for enclosing said pipe to form a hermetic space between said covering member and said pipe;
a valve provided in said covering member;
a pressure measuring device for measuring a pressure in said hermetic space; and
a decision unit for deciding on the basis of a value measured by said pressure measuring device whether a breakage has occurred in said pipe, wherein
the same gas or liquid as the one flowing through said pipe is sealed in said hermetic space through said valve.

9. The piping structure having leak detection function according to claim 8, being connected to chemical vapor deposition equipment, wherein a source gas or an ambient gas to be supplied to said chemical vapor deposition equipment is passed through said pipe.

10. The piping structure having leak detection function according to claim 8, wherein the pressure in said hermetic space is set to be higher than a pressure produced in said pipe when a gas or liquid flows therethrough.

11. The piping structure having leak detection function according to claim 8, wherein said pipe is a flexible hose.

12. The piping structure having leak detection function according to claim 11, wherein said flexible hose is made of a stainless steel material.

13. The piping structure having leak detection function according to claim 8, wherein said covering member is made of a synthetic resin.

14. The piping structure having leak detection function according to claim 8, further comprising an alarm device for activating an alarm when said decision unit decides that a breakage has occurred.

15. A leak detector comprising:
a covering member for enclosing a pipe allowing a gas or liquid to flow therethrough to form a hermetic space between said covering member and said pipe;
a pressure measuring device for measuring a pressure in said hermetic space; and
a decision unit for deciding on the basis of a value measured by said pressure measuring device whether a breakage has occurred in said pipe, wherein
the same gas or liquid as the one flowing through said pipe is sealed in said hermetic space.

16. The leak detector according to claim 15, further comprising an alarm device for activating an alarm when said decision unit decides that a breakage has occurred.

17. A leak detector comprising:
a covering member for enclosing a pipe allowing a gas or liquid to flow therethrough to form a hermetic space between said covering member and said pipe;
a valve provided in said covering member;
a pressure measuring device for measuring a pressure in said hermetic space; and
a decision unit for deciding on the basis of a value measured by said pressure measuring device whether a breakage has occurred in said pipe, wherein
the same gas or liquid as the one flowing through said pipe is sealed in said hermetic space from said valve.

18. The leak detector according to claim 17, further comprising an alarm device for activating an alarm when said decision unit decides that a breakage has occurred.
